(19) United States
(12) Patent Application Publication
(10) Pub. No.: US 2014/0315492 A1
(43) Pub. Date: Oct. 23, 2014

(54) CONTENT DELIVERY TO A SECONDARY DEVICE VIA A PRIMARY DEVICE

(71) Applicant: salesforce.com, inc., San Francisco, CA (US)

(72) Inventor: Joshua Michael Woods, San Francisco, CA (US)

(73) Assignee: salesforce.com, inc., San Francisco, CA (US)

(21) Appl. No.: 14/257,857

(22) Filed: Apr. 21, 2014

Related U.S. Application Data
(60) Provisional application No. 61/814,463, filed on Apr. 22, 2013.

(51) Int. Cl. H04W 4/00

(52) U.S. Cl. CPC H04W 4/008
USPC 455/41.2

(57) ABSTRACT

Systems, methods and apparatus are disclosed for providing secondary content to a secondary device from a primary device. The secondary content is content that is related to primary content being provided to the primary device, and that is to be executed and rendered at the secondary device. The primary device is paired with the secondary device. This pairing includes establishing a connection between the primary device and the secondary device. The primary device and the secondary device can then negotiate establishment of secondary content delivery session between the primary device and secondary device. When the secondary content delivery session is established between the primary device and the secondary device, the primary device can communicate the secondary content to the secondary device.

### CROSS-REFERENCE TO RELATED APPLICATION(S)

This application claims the benefit of U.S. provisional patent application Ser. No. 61/814,463, filed Apr. 22, 2013.

### TECHNICAL FIELD

Embodiments of the subject matter described herein relate generally to content delivery. More particularly, embodiments of the subject matter relate to delivery of secondary content to a secondary device via a primary device.

### BACKGROUND

In today's society, the use of portable electronic communication devices, such as tablets, smartphones and other such computing devices having touch screens, is widespread. Recently, there has been an increased interest in using these devices as a “second screen.” A second screen refers to the use of display of a secondary device to provide secondary content via a second screen application. The secondary content is related to primary content that is rendered on another display of a primary device, such as a television program displayed on a television or other viewing device. The secondary content enhances the user's experience while they are consuming (e.g., viewing, listening, reading, interacting with, etc.) the primary content. This way, the user can use their secondary device to interact with secondary content during communication of the primary content. Many second screen applications are designed to give a user another form of interactivity with the primary content.

More recently, second screen applications have evolved, sometimes referred to as a companion or cooperative applications, that attempt to exploit availability of the “second screen.” In many of these applications, the primary content and the secondary content are delivered to the primary device and the secondary device as two separate pieces. The second screen application is a standalone application that provides content that is separate from content delivered to a primary device that includes the application of the primary screen. That is, the second screen application is a completely separate application that is independent of the content delivered to the primary screen. The two devices could possibly connect to the same central server, but the content for the second screen application is generated and delivered completely independently of content that is delivered to the primary screen. For example, a wireless communication device can connect to a service to request and obtain content for the second screen, while a television is connected to a service provider that delivers content that is displayed on the primary screen.

This separate nature of the primary and secondary screen applications can make it difficult for software developers of secondary screen applications to build applications that work in coordination (e.g., where the secondary application influences the primary application) and that deliver content for the primary and secondary screens in a coordinated way. The developer of the second screen application would need to know details about how the application for the primary device would interact with the application for the secondary device. In many cases, the developers of the secondary application simply do not have adequate knowledge about the primary application to understand how it should interact with the secondary application.

Another problem with this approach is that there is no way to sandbox or isolate two applications that provide content for the primary and secondary devices. Ideally, a conventional second screen application would be communicate with the same server that the primary device is served by, but this can be a problem because the primary device may be allowed access the server, whereas the secondary device may not. For instance, in systems with a hierarchical role model, a user of a primary device at one permission level may have access to applications, data, and database information accessible to a lower permission level user, but the same user, when using their secondary device may not have access to the same applications, database information, and data accessible. Thus, depending on a user's security or permission level, different devices may have different permissions with regard to accessing and modifying application and database information.

Corporations desiring to allow their employees to utilize their secondary devices at work lack a system that addresses security concerns. For instance, there is often no way for someone to use their primary device (e.g., corporate desktop) in conjunction with a second screen application on their secondary device (e.g., personal tablet device). As another example, a customer may be able to access a server with their primary device (e.g., personal desktop), but may be unable to access that same server with their secondary device (e.g., tablet computer) due to security concerns.

In view of the above, it would be desirable to provide alternative methods, systems and apparatus for delivering secondary content to a secondary device.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 illustrates a block diagram of an example system in accordance with some of the disclosed embodiments;

FIG. 2 illustrates a block diagram of a primary device and a secondary device that may be used to implement the embodiments described herein;

FIG. 3 is a flowchart that illustrates a method for providing secondary content via a secondary device from a primary device in accordance with the disclosed embodiments; and

FIG. 4 is a diagram that illustrates a method performed by a primary device and a secondary device for processing events as part of a bi-directional event communication loop between the primary device and the secondary device in accordance with the disclosed embodiments.

### DETAILED DESCRIPTION

As used herein, the term “content” refers to textual, visual or aural information that is encountered as part of a user experience with an application. Content may include text, images, sounds, videos and animations. In addition, as used herein, the term “application content” refers to content of an application that can also include application logic that is provided in conjunction with content to execute, render and/or display that content.

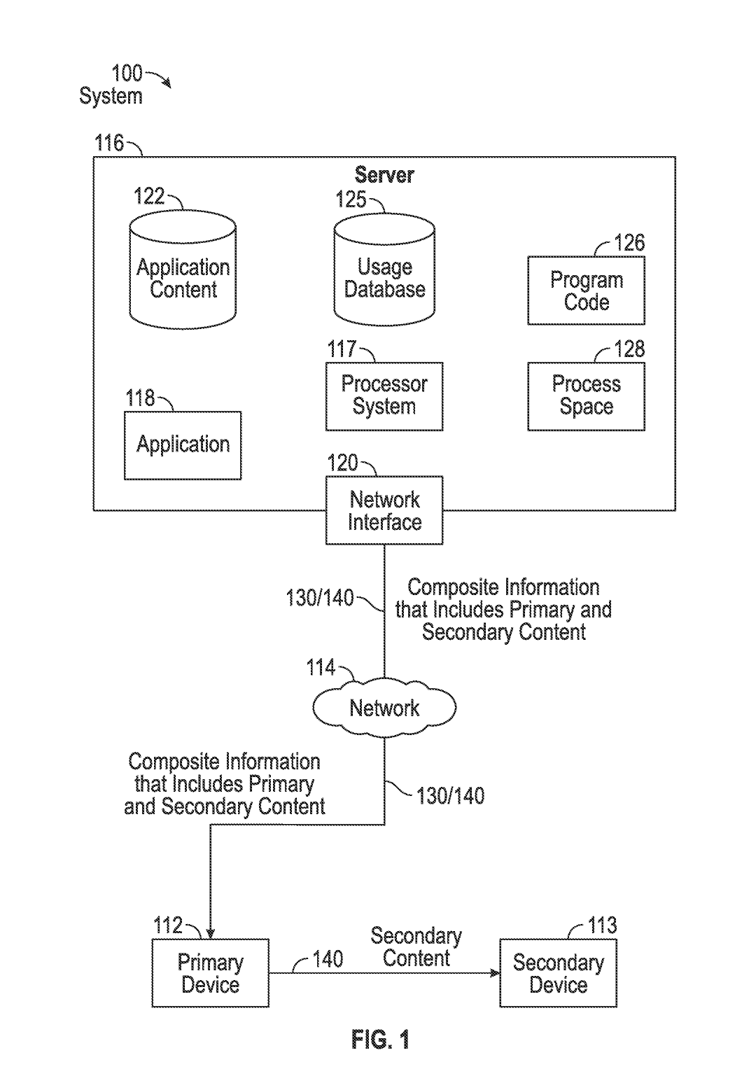

FIG. 1 illustrates a block diagram of an example system 100 in accordance with some of the disclosed embodiments.

System 100 may include a primary device 112, a secondary device 113, a network 114, and an application server 116 that generates, provides and communicates primary application content 130 for the primary device 112 and secondary application content 140 for the secondary device 113 via the primary device 112. In other embodiments, system 100 may not have all of the components listed and/or may have other elements instead of, or in addition to, those listed above. For example, in some embodiments, additional content sources (not illustrated) of primary application content 130 and secondary application content 140 can be provided that can be implemented at the server 116 or external to the server 116.

As will be described in greater detail below, the system 100 can be used to provide secondary application content 140 to the secondary device 113 from the primary device 112. The secondary application content 140 is content that is related to primary application content 130 being provided to the primary device 112, and that is to be executed and rendered at the secondary device 113. As will also be described in greater detail below, it should be noted that the primary device 112 can be paired with the secondary device 113. This pairing includes, at a minimum, establishing a connection between the primary device 112 and the secondary device 113. This pairing allows the primary device 112 and the secondary device 113 to negotiate establishment of secondary content delivery session between the primary device 112 and the secondary device 113. Once the secondary content delivery session is established between the primary device 112 and the secondary device 113, in one embodiment, the primary device 112 can serve as a proxy that communicates the secondary application content 140 to the secondary device 113. In another alternative embodiment, there is still a communication mechanism between the primary device 112 and the secondary device 113, but the secondary device 113 directly requests additional content as needed. One benefit of this alternative embodiment is that the application logic for both the primary device 112 and the secondary device 113 can still be distributed as a single unit, and also the primary and secondary applications can still interact directly. As an example, if the secondary application is a control pad for the primary application (e.g., Microsoft Word Office), then pressing a button on the secondary device may edit a document, but the secondary application could still access online data services directly to, for instance, define a word as there may be no need to authorize in this particular instance.

Primary application content 130 can originate from a primary content source including, for example, the server 116. The primary application content 130 is provided or delivered to the primary device 112, and includes information that is executed and/or rendered and/or displayed at the primary device 112. The primary application content 130 may be, for example, text, data, audio, video and/or image information.

The secondary application content 140 is special or additional content that enhances the primary application content 130 that is being executed, rendered, and/or displayed at the primary device 112. In some cases, the secondary application content 140 provides interactivity with primary application content 130 that is executed, rendered, and/or displayed at the primary device 112. In other cases, the secondary application content 140 provides additional information that supplements the primary application content 130. As used herein, the secondary application content 140 may comprise auxiliary or supplemental information that is to be executed and/or rendered and/or displayed at the secondary device 113 to enhance the primary application content 130 being delivered to the primary device 112. In some embodiments, the secondary application content 140 is provided as an augmentation to the primary application content 130 providing alternative content such as displays, options, enhancement material, etc. In other embodiments, the secondary application content 140 may completely replace some content provided as primary application content 130. Finally, in still other embodiments, the secondary application content 140 may be completely separate from the primary application content 130, and may simply be a media alternative that the user may choose to utilize.

In some embodiments, the application that provides the secondary application content 140 demarcates it so that it is distinguishable from the primary application content 130. In addition, in some embodiments, the secondary application content 140 is exclusively for the secondary device 113 such that it can be executed, rendered and/or displayed only at the secondary device 113, but not at the primary device 112. In accordance with the disclosed embodiments, the secondary application content 140 can be communicated first to the primary device 112, and then extracted via the primary device 112 and communicated to the secondary device 113 so that it can be executed and/or rendered and/or displayed at the secondary device 113.

In one embodiment, illustrated in FIG. 1, the secondary application content 140 can be stored at the storage 122 of the server 116. In some embodiments, the secondary application content 140 can include content that originated from other sources that are external to the server 116. For example, a user of the primary device 112 may also obtain secondary application content 140 from a network without necessarily having the secondary application content 140 being provided from or by the server 116. Additionally, the secondary application content 140 may be content requested by the user.

The server 116 is connected to the network 114 and can communicate with other devices that are also connected to the network 114. The server 116 is a content server configured to provide the secondary application content 140 that is to be executed, rendered and/or displayed at the secondary device 113. The server 116 can provide services associated with the application 118 to the secondary device 113 via the primary device 112. In some embodiments, including the one illustrated here, the server 116 may also provide the primary application content 130 for display on the primary device 112. For instance, the server 116 is configured to provide code, webpages, forms, applications, data, media content and other information to the primary device 112. The primary device 112 serves as a proxy to provide some of this content to the secondary device 113.

In one embodiment, the server 116 can be associated with a cloud service provider. The server 116 may provide resources to customers (e.g., end users) as a service.

Each of the elements of the server 116 can be co-located or distributed depending on the implementation. Although shown in a single box, the application server 116 may be distributed at locations remote from one another (e.g., one or more servers located in city A and one or more servers located in city B), and can include one or more logically and/or physically connected servers distributed locally or across one or more geographic locations. Additionally, the term “server” is meant to include a computer system, including processing hardware and process space(s), and an associated storage system. Further, additional content sources (not illustrated) from external content providers can be communicatively coupled to the server 116 in some implementations.

The server 116 that may include a processor system 117, application 118, network interface 120, storage 122 for content including application content, a usage database 125, program code 126 for implementing various functions of server 116, and process space 128 for executing system processes, such as running applications 118 and additional processes that may execute on server 116.

The server 116 can be accessed via the interface 120. The network interface 120 can be any conventional wired or wireless networking interface.

The processor system 117 can be any known type of processor capable of processing computer-executable instructions. The application 118 may include any number of applications that the application server 116 can run. The terms “application,” “software application,” “software package,” “software code,” and “program code” are used interchangeably.

In one embodiment, storage 122 stores primary application content 130 and secondary application content 140. The application 118 can be executed by the processor system 117 to provide/deliver the secondary application content 140 that is stored in storage 122.

The program code 126 can include instructions that are executable by the processor system for implementing a personalization engine that analyzes the usage habits of a user and makes recommendations based on those usage habits. The usage habits for a user can be stored in the usage database 125.

Network 114 is any network or combination of networks of devices that communicate with one another, such as the global internetwork of networks often referred to as the “Internet.” That network will be used in many of the examples herein. However, it should be understood that the networks used with the embodiment described herein use are not so limited, although TCP/IP is a frequently implemented protocol. While embodiments are suitable for use with the Internet, it should be understood that other networks can be used instead of the Internet, such as an intranet, an extranet, a virtual private network (VPN), a non-TCP/IP based network, any local area network (LAN), wide area network (WAN) or the like. For example, network 114 can be any one or any combination of a LAN, a WAN), telephone network, wireless network, point-to-point network, star network, token ring network, hub network, or other appropriate configuration.

Although not illustrated, it should be appreciated that the network 114 can include infrastructure that is not illustrated including other servers, content providers, infrastructure associated with a cellular network, infrastructure associated with a local area network, etc. Each of the other entities in FIG. 1 are capable of communicating with any of this infrastructure.

The capabilities of primary device 112 and the secondary device 113 may differ in their respective characteristics, capabilities, capacities, security permissions, etc.

In general, the primary device 112 is a device that includes a display for displaying primary application content 130 along with other conventional hardware, firmware and software as is known in the art. Examples of primary device 112 can include, but are not limited to, a television, monitor, projector, or the like. The primary device 112 may be a conventional 2-D type display or may alternatively be an advanced 3-D display. The primary device 112 may include, or be connected to, a receiving device (not illustrated) that can provide the primary application content 130 and the secondary application content 140 to the primary device 112. In certain embodiments, the primary device 112 may connect to the network 114 using a wired or wireless connection to provide connectivity to the network 114 and server 116. The primary device 112 may be in non-networked communication or networked communication with the secondary device 113. Examples of such non-networked communication include, but are not limited to, radio frequency (RF), and infrared (IR), Blue-Tooth, and other communication techniques and protocols.

Depending on the implementation, the secondary device 113 can be, for example, a handheld computing device, a smart phone, a mobile phone, a tablet computer, personal media player (e.g., iPod), a wireless access protocol (WAP) enabled device, a PDA, a laptop computer, a desktop personal computer, a work station, a network of computing devices, a watch, a gaming pad, a fitness device, personal attire, an entertainment device, computer accessories, input devices, or output devices, a WLAN or Bluetooth enabled device or any other computing device capable of interfacing directly or indirectly to the Internet (or other network connection), and with the primary device 112.

In one embodiment, the secondary device 113 can include a touch screen control device that allows operation based on hand movements, or gestures, and actions translated through the panel into commands. The secondary device 113 serves as the display device that allows a user to interact with secondary content. The secondary device 113 is device capable of displaying secondary application content 140 related to the primary application content 130 being executed, rendered and/or displayed at the primary device 112. For example, the secondary device 113 may be capable of displaying video content such as graphics entries, user interface entries, etc. that are related to a portion of the primary application content 130 that is delivered to the primary device 112.

As mentioned above, the primary device 112 and the secondary device 113 can be paired with and interfaced to each other such that they can communicate with each other using either network 114, non-networked communication, or both. The primary device 112 and the secondary device 113 may interface with each other using any well-known signal transmission system, such as infra-red (IR) or radio frequency (RF) communications and may include standard protocols such as infra-red data association (IRDA) standard, Wi-Fi, Bluetooth and the like, or any other proprietary protocols. The secondary device 113 interfaces with the primary device 112 so that the secondary device 113 can communicate with the server 116 via the primary device 112 to request and receive content related to the primary application content 130.

The primary device 112 and the secondary device 113 can both run/execute an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user to access, process and view information, pages and applications available to it from application server 116. In one embodiment, the primary device 112 may communicate with application server 116 using TCP/IP and, at a higher network level, use other common Internet protocols to communicate, such as hypertext transfer protocol (HTTP), file transfer protocol (FTP), Andrew file system (AFS), wireless application protocol (WAP), etc. In an example where HTTP is used, the primary device 112 might include an HTTP client commonly referred to as a “browser” for sending and receiving HTTP messages to and from an HTTP server at application server 116. Such an HTTP server might be implemented as the sole network interface between application server 116 and network 114, but other techniques might be used as well.

Although the primary device 112 and the secondary device 113 are each capable of interacting with the server 116 via the network 114, in accordance with the disclosed embodiments, the secondary device 113 does not need to be connected to the server 116 or the 117. Rather, in accordance with the disclosed embodiments, the primary device 112 has a connection to a server 116, and serves a proxy between the server 116 and the secondary device 113 that provides the secondary application content 140 to the secondary device 113 so that the secondary device 113.

In this regard, the primary device 112 can be seen as a server application that manages the information that is provided to the secondary device 113. The primary device 112 can obtain information about the characteristics, configuration and capabilities of the secondary device 113, can determine whether the secondary device 113 is available for consumption of secondary application content 140, can determine whether there is any secondary application content 140 available for the secondary device 113 (e.g., that is related or relevant to the primary application content 130), and can also coordinate passing of events back and forth between the primary device 112 and the secondary device 113.

In accordance with some of the disclosed embodiments, when the primary device 112 receives the primary application content 130 and the secondary application content 140, the primary device 112 can separate the primary application content 130 from the secondary application content 140 and then deliver the secondary application content 140 to the secondary device 113. The primary application content 130 is consumed at the primary device 112, whereas the secondary application content 140 is provided to the secondary device 113. This way, the primary application content 130 can be executed/rendered/displayed at the primary device 112 and secondary application content 140 can be executed/rendered/displayed at the secondary device 113. In one embodiment, the secondary device 113 has a thin client that controls the actual rendering of the secondary application content 140. The secondary device 113 receives commands from the primary device 112, and executes commands and renders the secondary application content 140 provided from the primary device 112 per the instructions of the primary device 112.

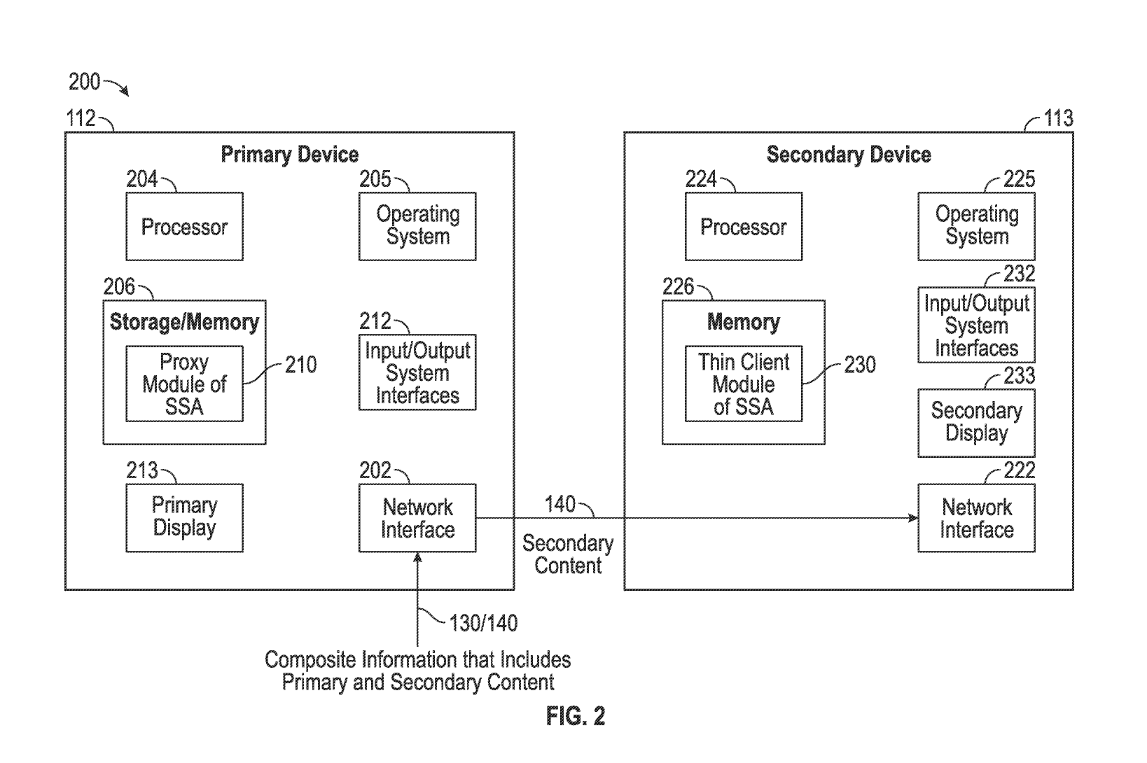

Example embodiments of the primary device 112 and the secondary device 113 will now be described with reference to FIG. 2.

FIG. 2 illustrates a block diagram of a system 200 that includes a primary device 112 and a secondary device 113 that may be used to implement the embodiments described herein.

The primary device 112 includes a network interface 202, a processor 204, an operating system 205, storage/memory 206, input/output system interfaces 212, and a primary display 213 (sometimes referred to as a “primary screen”). Similarly, the secondary device 113 includes a network interface 222, a processor 224, an operating system 225, storage/memory 226, input/output system interfaces 232, and, and a secondary display 233 (sometimes referred to as a “second screen”).

Input/output system interfaces 212, 232 can be communicatively coupled to one or more user interface devices, such as a keyboard, a mouse, trackball, touch pad, touch screen, pen or the like, for interacting with a graphical user interface (GUI) provided on a display (e.g., a monitor screen, liquid crystal display (LCD) monitor, etc.).

Input/output system interfaces 212, 232 may include interfaces to input devices (e.g., a keyboard, a mouse, a touchscreen, etc., and other means for receiving information from a user and/or from other devices), as well as interfaces to output devices (e.g., a display, monitor, etc., and other means for outputting information to a user and/or to other devices). For example, input/output system interfaces 212 include an interface to a primary display 213 of the primary device 112, whereas the input/output system interfaces 232 includes an interface to a secondary display 233 of the secondary device 113. The interface to the secondary screen 233 of the secondary device 113 can be used to interact in conjunction with pages, forms, applications and other information provided by application server 116 (via the primary device 112) or other systems or servers. A user interface device can be used to access data and applications hosted by application server 116, and to perform searches on stored data, and otherwise allow a user to interact with various GUI pages that may be presented to a user.

For ease of illustration, FIG. 2 shows one block for each of the processors 204, 224 and storage/memory 206, 226. These blocks 204, 224 and 206, 226 may each represent multiple processors and memory units. While various elements of the system 200 are described in conjunction with performing various steps/tasks/acts as described in the embodiments herein, any suitable component or combination of components of system 200 or any suitable processor or processors associated with system 200 may perform the steps/tasks/acts described.

The storage/memory 206 stores a proxy module 210 for the second screen application, and the storage/memory 226 stores a thin client module 230 for the second screen application. Modules 210, 230 associated with a second screen application can provide instructions that enable the processors 204, 224 to perform the functions described herein, such as steps that are described with reference to FIGS. 1, 3 and 4. Each of the modules 210, 230 may be stored in storage/memory 206, 226 or on any other suitable non-transitory computer-readable medium so that the modules 210, 230 can be loaded and executed at their respective processors 204, 224.

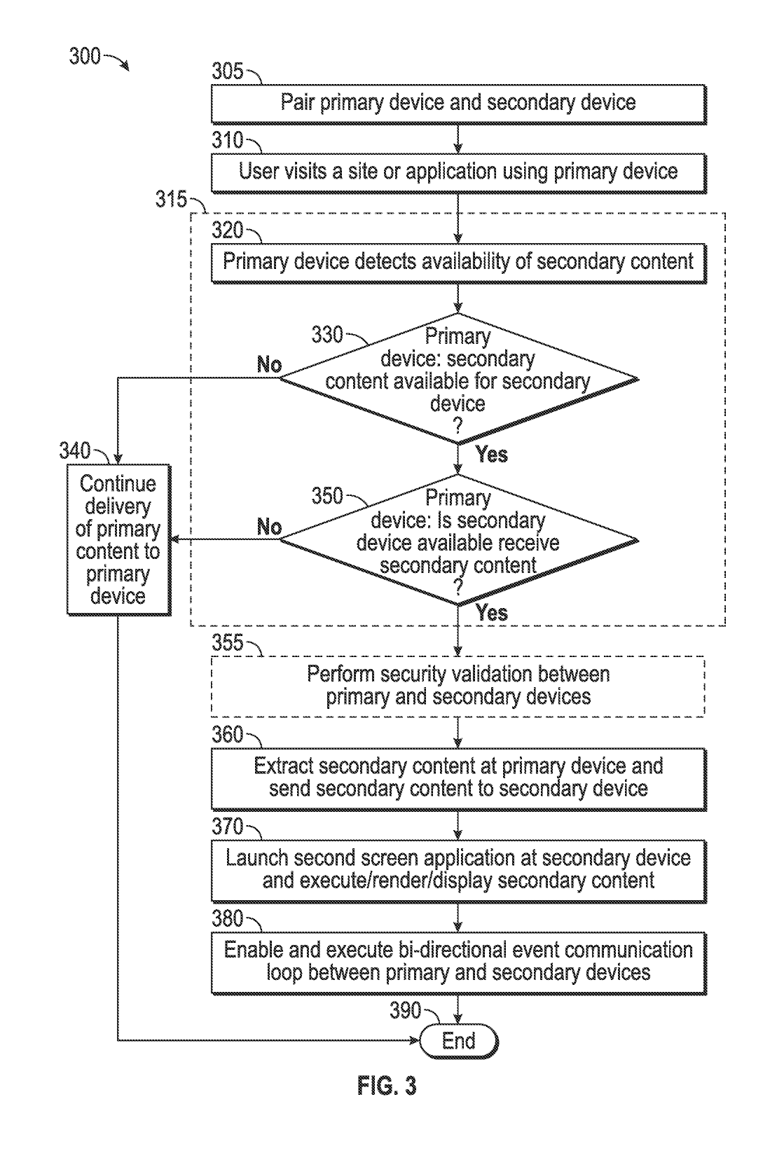

FIG. 3 is a flowchart that illustrates a method 300 for providing secondary application content 140 to a secondary device 113 via a primary device 112 in accordance with the disclosed embodiments. The method 300 of FIG. 3 will be described below with reference to FIGS. 1 and 2. As a preliminary mater, it should be understood that steps/tasks/acts of the method 300 are not necessarily presented in any particular order and that performance of some or all the steps/tasks/acts in an alternative order is possible and is contemplated. The steps/tasks/acts have been presented in the demonstrated order for ease of description and illustration. Further, steps/tasks/acts can be added, omitted, and/or performed simultaneously without departing from the scope of the appended claims. It should also be understood that the illustrated method 300 can end at any time. In certain embodiments, some or all steps/tasks/acts of this process, and/or substantially equivalent steps/tasks/acts, are performed by execution of processor-readable instructions stored or included on a processor-readable medium, for example. For instance, references to a processor performing functions of the present disclosure refer to any one or more interworking computing components executing instructions, such as in the form of an algorithm, provided on at least one non-transitory processor-readable medium, such as a memory associated with the primary device 112, the secondary device 113, the server 116, etc.

At, or prior to, the start of method 300, at step/task/act 305, the primary device 112 and the secondary device 113 are “paired” with each other meaning that the primary device 112 and the secondary device 113 establish a communication link or connection with each other. In one implementation, the primary device may be paired to the secondary device using a browser on the primary device. The process used to pair the primary device 112 and the secondary device 113 can vary depending on the implementation. In some implementations, the pairing interaction and protocol can leverage existing approaches. For instance, in one implementation, depending on the configuration of the devices, the devices may be paired using Bluetooth or communication directly between devices 112, 113.

As part of the pairing process, the primary device 112 and the secondary device 113 can also exchange data over a wired or wireless communication link regarding the properties, characteristics, capabilities and/or configuration of the secondary device 113. This could be driven via protocol/meta-data, or via explicit configuration. This way the primary device 112 becomes aware of one or more properties of the secondary device 113, such as performance capabilities, screen resolution, etc. As will be explained in greater detail below, because the secondary device 113 has been paired with the primary device 112, the secondary device 113 can receive secondary application content 140 directly from the primary device 112 without any direct connection to or communication with the server 116.

At step/task/act 310, the primary device 112 accesses the application at the server 116 (e.g., when user of primary device 112 visits a web site that hosts the application).

Following step/task/act 310, the primary device 112 performs steps/tasks/acts 315 to negotiate establishment of secondary content delivery session with the secondary device 113. In the particular embodiment illustrated in FIG. 3, this negotiation process used to establish the secondary content delivery session is represented by steps/tasks/acts encompassed within dotted-line block 315; however, not all of the steps/tasks/acts need to be performed in all embodiments, and additional steps/tasks/acts that are not illustrated could be performed in other embodiments. In this embodiment, the negotiation process is controlled by the primary device 112. For instance, in one implementation, a browser on the primary device 112 may control whether the secondary device 113 should be used based on one or more usage rules, such as whether an application has been previously approved to take over the secondary device, only using the second screen after first prompting the user for consent, and so forth. Existing negotiation techniques, such as user agents, and media queries may also be used to provide a system that controls the usage of the secondary device 113.

At step/task/act 320, a proxy module 210 at primary device 112 determines (e.g., detects) whether any secondary application content 140 that is relevant or related to the primary application content 130 is potentially available for the secondary device 113. For instance, in one implementation, the proxy module 210 can determine whether any secondary application content 140 is available for the secondary device 113 by processing application code and receiving an instruction demarcating application content that is intended for the secondary device. In another implementation, the primary device 112 receives a descriptor from the server 116 that describes at least one type of secondary application content 140 that is associated with the primary application content 130. Based on the descriptor, the proxy module 210 can determine that secondary application content 140 that is relevant or related to the primary application content 130 is available.

At step/task/act 330, the primary device 112 determines, based, for example, on the data obtained during pairing with the secondary device 113, whether any of the secondary application content 140 that is available is compatible with characteristics, capabilities and/or configuration the secondary device 113. When the primary device 112 determines that no such secondary application content 140 is available, the method 300 proceeds to step/task/act 340, where the primary device 112 can continue to deliver primary application content 130 to the primary device 112.

When the primary device 112 determines that secondary application content 140 is available that is compatible with characteristics, capabilities and/or configuration the secondary device 113, the method 300 proceeds to step/task/act 350, where the primary device 112 can determine whether the secondary device 113 is available to receive, execute, render and/or display the secondary application content 140. For instance, the browser of the primary device 112 may have controls that limits second screen usage to particular applications, and may include a preference to prompt the user so as not to take over the second screen without consent. In addition, the secondary device 113 may have restrictions on when it should be allowed to be “taken over” by a primary device 112. On the other hand, the primary device 112 may also enforce security constraints. When the primary device 112 determines that the secondary device 113 is not available to receive, execute, render and/or display the secondary application content 140, the method 300 proceeds to step/task/act 340, where the primary device 112 can continue to deliver primary application content 130 to the primary device 112.

When it is determined that the secondary device 113 is available to receive, execute, render and/or display the secondary application content 140, and the secondary content delivery session is established between the primary device 112 and the secondary device 113. In the embodiment illustrated in FIG. 3, the primary device 112 and the secondary device 113 perform steps/tasks/acts 360, 370 and 380 to conduct the secondary content delivery session between the primary device 112 and the secondary device 113. As such, in the particular embodiment illustrated in FIG. 3, this communication process used to communicate the secondary application content 140 from the primary device 112 to the secondary device 113 is represented by steps/tasks/acts 360, 370, 380. However, not all of the steps/tasks/acts need to be performed in all embodiments, and additional steps/tasks/acts that are not illustrated could be performed in other embodiments. For example, in accordance with some embodiments, an optional step/task/act 355 can be performed prior to proceeding to step/task/act 360. At step/task/act 355, a security validation process can be performed between the primary device 112 and the secondary device 113. In this regard, a “security validation process” can refer to a process whereby the primary device 112 and the secondary device 113 negotiate a secure communication protocol (e.g., SSL or some similar process). In addition, the primary device 112 and the secondary device 113 could also perform some additional checks/requirements that would need to be satisfied policy-wise for security to be validated. This security validation process can be used to confirm that the secondary device 113 is trusted and authorized to communicate with the primary device 112 and/or permitted to receive secondary application content 140 from the primary device 112. As one non-limiting example, a corporate laptop may be configured to only allow secondary screen usage on MS Office and only allow an iPad to be the secondary screen device (and perhaps a specific iPad approved via some process for that user). Alternatively, a secondary device like an iPad, may be configured to only allow applications from a specific provider to run, or only those that are signed via some mechanism.

Prior to step/task/act 360, the primary device 112 and the secondary device 113 can negotiate which secondary application should be launched. Depending on the implementation, this secondary application may be an application execution environment inherent to the system like a browser, or could be a true application. At step/task/act 360, the primary device 112 can extract the secondary application content 140 that is to be executed, rendered and/or displayed at the secondary device 113, and can communicate the secondary application content 140 directly to the secondary device 113. The secondary application content 140 can be communicated from the primary device 112 to the secondary device 113 several different ways. Various methods of synchronous and asynchronous communications may be used to enable delivery of the secondary application content 140 to the secondary device 113. Triggers for sending the secondary application content 140 to the secondary device 113 can be controlled by a synching mechanism associated with the primary application content 130.

The primary application content 130 and the secondary application content 140 can be communicated to the primary device 112 in a number of different ways depending on how the application 118 is designed.

For example, in one embodiment, the primary application content 130 and the secondary application content 140 can be communicated as a multi-part response with multiple HTML documents (instead of one) or a pointer to a secondary document. In another embodiment, the primary device 112 can receive the application content that includes the primary application content 130 and the secondary application content 140 as a stream of composite information that includes a first portion (i.e., the primary application content 130) that is designed to be executed, rendered and/or displayed at the primary device 112, and a second portion (i.e., the secondary application content 140) that is distinct and demarcated from the first portion and that is designed to be executed, rendered and/or displayed only at the secondary device 113.

In one implementation, the primary device 112 can receive this stream of composite information from the server 116 and can separate or extract the secondary application content 140 from the composite information, and then communicate the secondary application content 140 to the secondary device 113. In other words, the primary device 112 can selectively determine which portions of the composite information are the secondary application content 140 that is to be communicated to the secondary device 113. For example, the primary device 112 can selectively determine which portion of the composite information should be sent to the secondary device 113 by interpreting computer-executable instructions or markers in the composite information to determine which portions of the composite information are the secondary application content 140 that is to be communicated to the secondary device 113. In one particular implementation, the primary application content 130 and the secondary application content 140 can be integrated with each other in an HTML document, and the portion of the HTML document that corresponds to the secondary application content 140 can be demarcated in a structured way as being second screen compatible (e.g., the introduction of a <second-screen> semantic tag with optional src attribute). Once the primary application content 130 and the secondary application content 140 returned to the primary device 112, the secondary application content 140 can be extracted and communicate to the secondary device 113, and thus keep the primary application content 130 and the secondary application content 140 synchronized.

At step/task/act 370, the secondary application and the thin client module 230 can be launched at the secondary device 113. Once the secondary application is launched, it can provide any content from the primary device 112 and the secondary device 113.The secondary device 113 can then begin to execute, render and/or display the secondary application content 140.

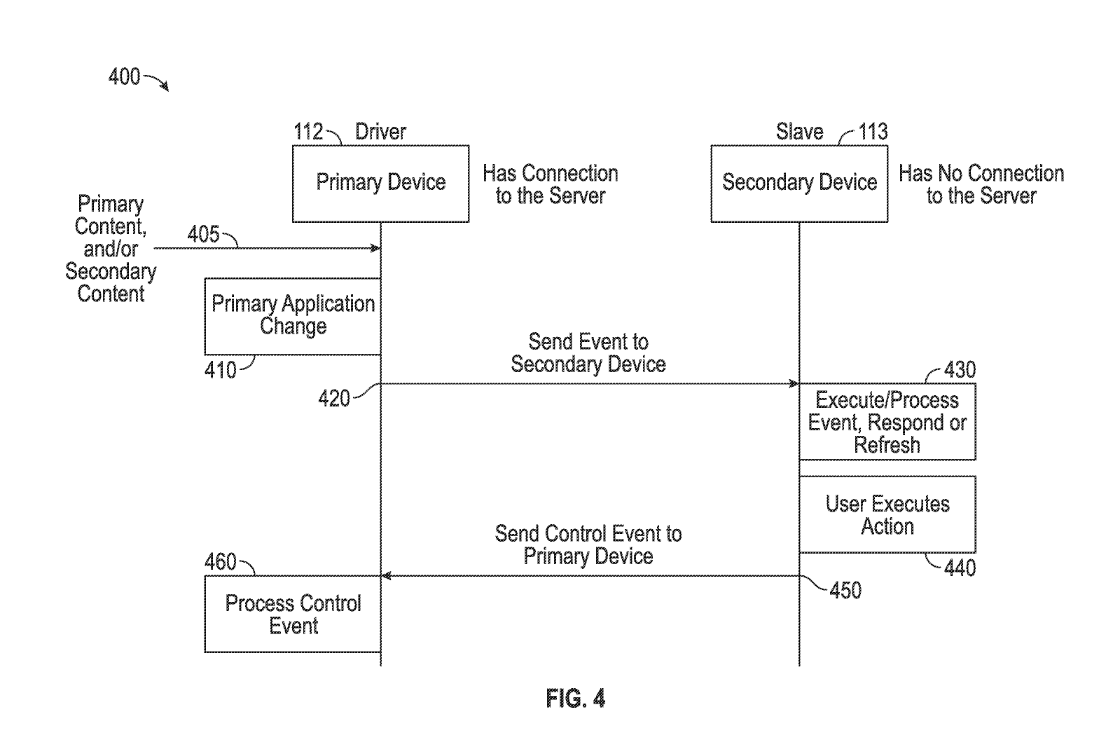

At step/task/act 380, a bi-directional event communication loop can be enabled between the primary device 112 and the secondary device 113 so that the primary device 112 and the secondary device 113 can continue communicating with each other. As will be explained in greater detail below with reference to FIG. 4, the bi-directional event communication loop between the primary device 112 and the secondary device 113 allows the primary device 112 to continue to communicate the secondary application content 140 from the primary device 112 to the secondary device 113, and allows the secondary device 113 to communicate feedback information to the primary device 112 to facilitate continued communication of the secondary application content 140 to the secondary device 113. Thus, as the secondary device 113 executes and renders the secondary application content 140, the secondary device 113 can communicate feedback information/events back to the primary device 112 to facilitate continued rendering of the secondary application content 140.

FIG. 4 is a diagram that illustrates a method 400 performed by the primary device 112 and the secondary device 113 for processing events as part of a bi-directional event communication loop 400 between the primary device 112 and the secondary device 113 in accordance with the disclosed embodiments.

At step/task/act 405, the primary device 112 receives the primary application content 130 and the secondary application content 140 communicated from the server 116. At step/task/act 410, a trigger occurs and the primary device 112 communicates commands corresponding to an event to the secondary device 113 at step/task/act 420. For instance, in the example illustrated in FIG. 4, the trigger could be that the primary device 112 determines that there was a change in the primary application content 130 (or alternatively in the secondary application content 140). As used herein, an “event” refers to a communication of status that may include corresponding content or application logic that can be executed, processed or interpreted at the receiving device (e.g., which is the secondary device 113 at steps/tasks/acts 420/430, but could be the primary device 112 at steps/tasks/acts 450/460). An event can be triggered by user interaction (e.g., pressing a key or button) or an application condition (e.g., a timer firing, or . . . ). At step/task/act 430, the thin client module 230 of the secondary device 113 processes/executes the commands to generate a response event. At step/task/act 440, a trigger occurs (e.g., a user of the secondary device 113 can execute an action by interacting with the application, or an application condition occurs), and the secondary device 113 can send information (e.g., labeled as a “control” event for contrast to the event at steps/tasks/acts 420/430) to the primary device 112 at step/task/act 450. This “control event” can an event as defined above. At step/task/act 460, the primary device 112 can process the control event. The bi-directional event communication and processing performed via loop 400 can repeat as the primary device 112 continues to receive the primary application content 130 and/or the secondary application content 140.

Thus, in accordance with the disclosed embodiments, computer-implemented methods, systems, apparatus and associated computer-readable media are provided that can pair a primary device with a secondary device and that allows the primary device to negotiate delivery of secondary content to the secondary device. The primary device has a communication connection to the server, whereas the secondary device does not need to be communicatively coupled to the server to receive secondary application logic and content. The primary device is capable of interacting with and/or controlling the secondary “paired” device. The primary device acts as a proxy that obtains the secondary content, for example, from an application hosted on a web server, and then extracts it and provides it to the secondary device. The secondary device to proxy its requests for secondary content through a primary device that already has permission to access a source of the secondary content (e.g., a server or other content source). This avoids the need for the secondary device to be connected to a server or the same network (e.g., the secondary device does not have to establish a communication connection with anything except the primary device) to access the remote application that provides the secondary content. The primary device not only acts as a proxy, but also provides a security layer with respect to the secondary device so that security provided at the primary device can be leveraged. This is beneficial from a security standpoint since it can allow the secondary device to be used and trusted without having to establish a trust relationship and without having to manage the security of the secondary device.

Further, in accordance with some of the disclosed embodiments, applications can be written that can provide both primary and secondary content (e.g., the secondary content that should be sent to the secondary device from the primary device is demarcated from the primary content that should be delivered to the primary device). In other words, a composite application can be served or delivered to the primary device, and then a portion of the content or information associated with that application can be provided to the secondary device. As such, the secondary application logic and content can be bundled or integrated with the primary content and delivered as one piece to the primary device and then separated by the primary device to provide the portion of the secondary content to the secondary device. Thus, an application can be written such that composite application data can be communicated to the primary device, and the primary device can then extract the secondary content and provide it to the secondary device, while executing/rendering/displaying another different portion of that application data (e.g., the primary content) at the primary device. This can allow the application to be written so that one portion runs on the primary device and another portion that runs on the secondary device. This can allow for the development of applications that have enhanced interactivity. This can be useful, for instance, in secure corporate environments, where the primary device is permitted to access the network, but where the secondary is not.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

The various tasks performed in connection with methods 300 and 400 may be performed by software, hardware, firmware, or any combination thereof. For illustrative purposes, the following description of methods 300 and 400 may refer to elements mentioned above in connection with FIGS. 1 and 2. In practice, portions of methods 300 and 400 may be performed by different elements of the described system, e.g., component A, component B, or component C. It should be appreciated that methods 300 and 400 may include any number of additional or alternative tasks, the tasks shown in FIGS. 3 and 4 need not be performed in the illustrated order, and methods 300 and 400 may be incorporated into a more comprehensive procedure or process having additional functionality not described in detail herein. Moreover, one or more of the tasks shown in FIGS. 3 and 4 could be omitted from an embodiment of the methods 300 and 400 as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for providing secondary application content to a secondary device from a primary device, the method comprising:
pairing the primary device and the secondary device, wherein pairing comprises:
establishing a connection between the primary device and the secondary device;
negotiating establishment of secondary content delivery session between the primary device and secondary device; and
communicating, when the secondary content delivery session is established between the primary device and the secondary device, the secondary application content that is to be executed and rendered at the secondary device from the primary device to the secondary device, wherein the secondary application content is related to primary application content being provided to the primary device.

2. A method according to claim 1, wherein negotiating establishment of the secondary content delivery session between the primary device and secondary device, comprises:
determining, at the primary device, availability of the secondary device to receive secondary application content if secondary application content is available to be provided to the secondary device.

3. A method according to claim 2, wherein pairing further comprises: providing data to the primary device regarding characteristics of the secondary device, and wherein determining, at the primary device, availability of the secondary device to receive secondary application content if secondary application content is available to be provided to the secondary device, comprises:
determining, at the primary device, whether secondary application content is available that is related to the primary application content, whether the secondary application content that is available is compatible with the characteristics of the secondary device that has been paired with the primary device, and whether the secondary device is available to receive the secondary application content.

4. A method according to claim 3, wherein communicating, from the primary device to the secondary device, the secondary application content that is to be executed and rendered at the secondary device, comprises:
when the primary device determines that secondary application content is available that is related to the primary application content, that the secondary application content that is available is compatible with the characteristics of the secondary device, and that the secondary device is available to receive the secondary application content, communicating, from the primary device to the secondary device, the secondary application content that is to be executed and rendered at the secondary device.

5. A method according to claim 1, further comprising:
communicating, from the server to the primary device, composite information that comprises the primary application content that is to be executed and rendered at the primary device and the secondary application content that is to be executed and rendered at the secondary device; and
extracting, at the primary device, the secondary application content from the composite information.

6. A method according to claim 5, wherein extracting comprises:
selectively determining, at the primary device, which portions of the composite information are the secondary application content that is to be communicated to the secondary device.

7. A method according to claim 1, further comprising:
receiving application logic and content at the primary device that includes the primary application content and the secondary application content, wherein the application logic and content comprises:
a first portion that includes the primary application content that is designed to be executed, rendered or displayed at the primary device, and
a second portion, that is distinct and demarcated from the first portion, wherein the second portion includes the secondary application content that is designed to be executed, rendered or displayed only at the secondary device.

8. A method according to claim 7, wherein the primary device has a communication connection to a server, wherein the secondary device is not communicatively coupled to the server, and further comprising:
accessing, at the primary device, the primary application content from the server;
receiving, at the primary device, the primary application content and the secondary application content;
wherein the secondary device receives the second portion directly from the primary device without any direct connection to or communication with the server.

9. A method according to claim 1, further comprising:
enabling a bi-directional event communication loop between the primary device and the secondary device.

10. A method according to claim 9, wherein the bi-directional event communication loop between the primary device and the secondary device includes:
communicating an event from the primary device to the secondary device; and
communicating, from the secondary device to the primary device, another event to facilitate continued communication of the secondary application content.

11. A method according to claim 10, wherein the bi-directional event communication loop between the primary device and the secondary device includes the steps of:
communicating, in response to a trigger the primary application content, an event from the primary device to the secondary device;
processing or executing the event at the secondary device to generate a response at the secondary device;
communicating, in response to another trigger at the secondary device 113, a control event from the secondary device to the primary device; and
processing or executing the control event at the primary device.

12. A method according to claim 1, further comprising:
performing a security validation process between the primary device and the secondary device to confirm that communications between the primary device and secondary device are secure prior to communicating, from the primary device to the secondary device, the secondary application content that is to be executed and rendered at the secondary device.

13. A system, comprising:
a server configured to generate primary application content;
a content source configured to generate secondary application content that is related to primary application content;
a secondary device; and
a primary device paired with the secondary device and communicatively connected to the secondary device and the server, wherein the primary device is configured to: negotiate establishment of secondary content delivery session between the primary device and secondary device, and when the secondary content delivery session is successfully established between the primary device and the secondary device, to directly communicate the secondary application content that is to be executed and rendered at the secondary device to the secondary device.

14. A system according to claim 13, wherein the primary device obtains data from the secondary device regarding characteristics of the secondary device during the pairing with the secondary device, and wherein the primary device is configured to negotiate establishment of the secondary content delivery session between the primary device and secondary device by determining whether secondary application content is available that is related to the primary application content, whether the secondary application content that is available is compatible with the characteristics of the secondary device, and whether the secondary device is available to receive the secondary application content.

15. A system according to claim 14, wherein the primary device is configured to communicate the secondary application content to the secondary device when the primary device determines that secondary application content is available that is related to the primary application content, that the secondary application content that is available is compatible with the characteristics of the secondary device, and that the secondary device is available to receive the secondary application content.

16. A system according to claim 13, wherein the server is configured to communicated composite information to the primary device, wherein the composite information comprises: the primary application content that is to be executed and rendered at the primary device and the secondary application content that is to be executed and rendered at the secondary device, and
wherein the primary device is configured to extract the secondary application content from the composite information by selectively determining which portions of the composite information are the secondary application content that is to be communicated to the secondary device.

17. A system according to claim 16, wherein the composite information comprises application logic and content that includes the primary application content and the secondary application content, wherein the primary application content is a first portion of the application logic and content that is designed to be executed, rendered or displayed at the primary device, and wherein the secondary application content is a second portion of the application logic and content that is distinct and demarcated from the first portion and that is designed to be executed, rendered or displayed at the secondary device.

18. A system according to claim 17, wherein the secondary device is not communicatively coupled to the server, and wherein the secondary device receives the second portion directly from the primary device without any direct connection to or communication with the server.

19. A system according to claim 13, when the secondary content delivery session is successfully established between the primary device and the secondary device, wherein a bi-directional event communication loop is enabled between the primary device and the secondary device in which the primary device communicates an to the secondary device in response to a trigger, the secondary device processes or executes the event to generate a response at the secondary device and communicates a control event to the primary device in response to another trigger at the secondary device, and the primary device processes or executes the control event.

20. A primary device that is capable of being paired with and communicatively coupled to a secondary device, the primary device comprising:
a first network interface capable of communicating with a server and receiving composite information that comprises: primary application content that is to be executed and rendered at the primary device and secondary application content that is related to the primary application content and that is to be executed and rendered at the secondary device;
a processor;
a memory, coupled to the processor, wherein the memory includes computer program instructions capable of: negotiating establishment of secondary content delivery session between the primary device and secondary device, and extracting the secondary application content from the composite information by selectively determining which portions of the composite information are the secondary application content that is to be communicated to the secondary device; and
a second network interface capable of directly communicating the secondary application content that is to be executed and rendered at the secondary device to the secondary device.

21. A secondary device that is capable of being paired with and communicatively coupled to a primary device, the secondary device comprising:
a processor;
a memory, coupled to the processor, wherein the memory includes computer program instructions capable of: negotiating establishment of secondary content delivery session between the primary device and secondary device; and
a network interface capable of directly receiving secondary application content that has been extracted by the primary device from composite information that also comprises primary application content, wherein the secondary application content is content that is to be executed and rendered at the secondary device, wherein the secondary application content is related to primary application content and that is to be executed and rendered at the primary device.
